(19) United States
(12) Patent Application Publication
(10) Pub. No.: US 2012/0040127 A1
(43) Pub. Date: Feb. 16, 2012

(54) STACKED OPTICAL ANTENNA STRUCTURES, METHODS AND APPLICATIONS

(75) Inventors: Lukas Novotny, Pittsford, NY (US); Wolfgang Dieter Pohl, Adliswil (CH)

(73) Assignee: University of Rochester, Rochester, NY (US)

(21) Appl. No.: 13/208,664

(22) Filed: Aug. 12, 2011

Related U.S. Application Data
(60) Provisional application No. 61/373,470, filed on Aug. 13, 2010.

(51) Int. Cl. B32B 3/00; B32B 37/00

(52) U.S. Cl. 428/77; 156/60

(57) ABSTRACT

A stacked optical antenna structure includes a stacked structure including: (1) a first antenna arm located over a substrate; (2) an interstitial gap layer located over at least a portion of the first antenna arm; and (3) a second antenna arm located over at least a portion of the interstitial gap layer located over the first antenna arm, and typically incompletely overlapping the first antenna arm. Thus, a gap width of the stacked optical antenna structure is determined by a thickness of the interstitial gap layer rather than a separation distance of antenna arms that may be formed using a photolithographic method. Embodiments also contemplate a method for fabricating the stacked optical antenna that uses the interstitial gap layer as an etch stop layer. The interstitial gap layer may provide any of several functions within the stacked optical antenna structure.

### CROSS-REFERENCE TO RELATED APPLICATIONS

This application is related to application Ser. No. 61/373,470, filed 13 Aug. 2010 and titled “Stacked Optical Antenna, Methods and Applications,” the content of which is incorporated herein fully by reference.

### BACKGROUND

1. Field of the Invention

Embodiments relate generally to optical antennas. More particularly, embodiments relate to enhanced performance optical antennas.

2. Description of the Related Art

Optical antennas comprise nanometer sized structures that convert free propagating optical radiation into an alternative localized energy source, and vice versa. To that end, optical antennas define an enabling technology for the control and manipulation of optical radiation fields on the nanometer size scale. Thus, optical antennas hold promise for enhancing the performance and efficiency of various photo detection processes, photo emission processes, and photon conversion processes on the nanometer size scale, and also on the single photon level.

In light of the potential for various applications of optical antennas, desirable are optical antenna structures with enhanced performance and methods for fabricating the optical antenna structures with enhanced performance.

### SUMMARY

Exemplary non-limiting embodiments provide an optical antenna structure and a method for fabricating the optical antenna structure. An optical antenna structure in accordance with the embodiments includes a first antenna arm located and formed over a substrate, an interstitial gap layer located and formed over at least a horizontal portion (and under certain circumstances also an adjoining vertical sidewall portion) of the first antenna arm and a second antenna arm located and formed over at least a portion of the interstitial gap layer that is located and formed over the first antenna arm. Within certain embodiments, appropriate planarizing layers may be included to provide a stacked optical antenna structure where any single one (or any combination of) the first antenna arm, the interstitial gap layer and the second antenna arm is provided as a planar layer (or is provided as planar layers). Typically, the second antenna arm and the first antenna arm incompletely overlap. Thus, an optical antenna structure in accordance with the illustrative non-limiting embodiments comprises at least in-part a vertically stacked optical antenna structure in accordance with the embodiments.

Such a vertically stacked optical antenna structure controls a gap width interposed between the first antenna arm and the second antenna arm within the context of a thickness of a deposited interstitial gap layer rather than through a photolithographic process step and a subsequent backfill and planarization process step that may be used within the context of an otherwise fully planar optical antenna structure.

The embodiments also provide that the interstitial gap layer located and formed interposed between the first antenna arm and the second antenna arm may comprise any of several interstitial gap layer materials to provide the stacked optical antenna structure in accordance with the embodiments with any of several properties that provide for particular desirable performance characteristics of the stacked optical antenna structure. Such interstitial gap materials may include, but are not necessarily limited to, dielectric materials (which may provide tunneling junction properties), non-linear optic materials (which may provide frequency shifting properties or optical switching properties), optical emitter or optical absorber materials embedded within a dielectric material (which may provide single photon optical properties), conductive oxide materials (which may provide optical modulation properties) and semiconductor materials including semiconductor junction materials (which may provide photovoltaic and electro-optic properties).

Depending on the dimensions and the materials of composition of the antenna arms, a vertically stacked optical antenna structure in accordance with the embodiments can operate in different wavelength regimes, spanning the ultraviolet, visible, near-infrared, infrared, terahertz, and microwave wavelength range bands.

An optical antenna structure in accordance with the embodiments includes a first antenna arm located over a substrate. The optical antenna structure also includes an interstitial gap layer located over at least a portion of the first antenna arm. The optical antenna structure also includes a second antenna arm located over at least a portion of the interstitial gap layer that is located over the first antenna arm.

A method for fabricating an optical antenna structure in accordance with the embodiments includes forming over a substrate a first antenna arm. The method also includes forming over at least a portion of the first antenna arm an interstitial gap layer. The method also includes forming over at least a portion of the interstitial gap layer formed over the first antenna arm a second antenna arm.

Within the embodiments and the claims that follow, use of the terminology “over” is intended to indicate an overlying relationship between a first layer or structure and a second layer or structure, and not necessarily contact between the first layer or structure and the second layer or structure. In contrast, use of the terminology “upon” is intended to indicate an overlying relationship between a first layer or structure and a second layer or structure, and contact between the first layer or structure and the second layer or structure. Finally, use of the terminology “over,” “upon,” and “covering” with respect to a first layer or structure relative to a second layer or structure may within context be related to either or both of a horizontal direction and a vertical direction. In addition, within the embodiments and the claims that follow, a substrate is intended as a horizontal base structure for determining and designating relative positions and locations of overlying layers or structures.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, which form a material part of this disclosure, wherein:

FIG. 1(a) shows a schematic perspective-view diagram illustrating a stacked optical antenna structure, which is shown as a linear stacked optical antenna structure in accordance with the embodiments, where specific stacked optical antenna structure dimensions are chosen for obtaining a resonance in the near-infrared wavelength range.

FIG. 1(b) and FIG. 1(c) show calculated electric field distributions near the stacked optical antenna structure in accordance with the embodiments in comparison with a planar optical antenna structure.

FIG. 2 shows a graph of light wavelength dependence and electric field enhancement in the gap of a stacked optical antenna structure in accordance with the embodiments.

FIG. 3 shows a schematic plan-view diagram and a schematic cross-sectional diagram of a stacked optical antenna structure including a bilayer semiconductor p-n junction interstitial gap layer in accordance with the embodiments.

FIG. 4(a) to FIG. 4(g) show a series of schematic cross-sectional diagrams and plan-view diagrams illustrating the results of progressive stages in fabricating a stacked optical antenna structure in accordance with the embodiments.

### DETAILED DESCRIPTION OF THE EMBODIMENTS

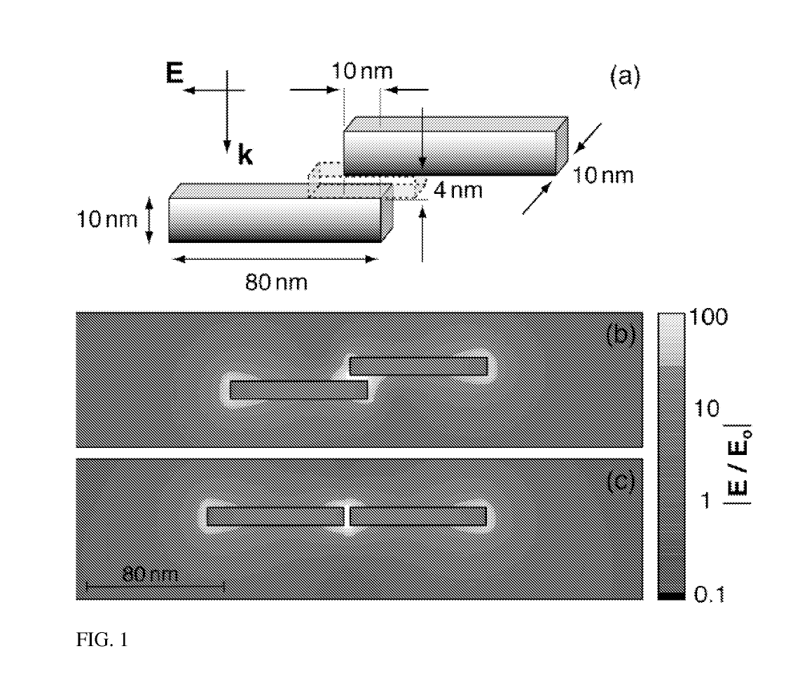

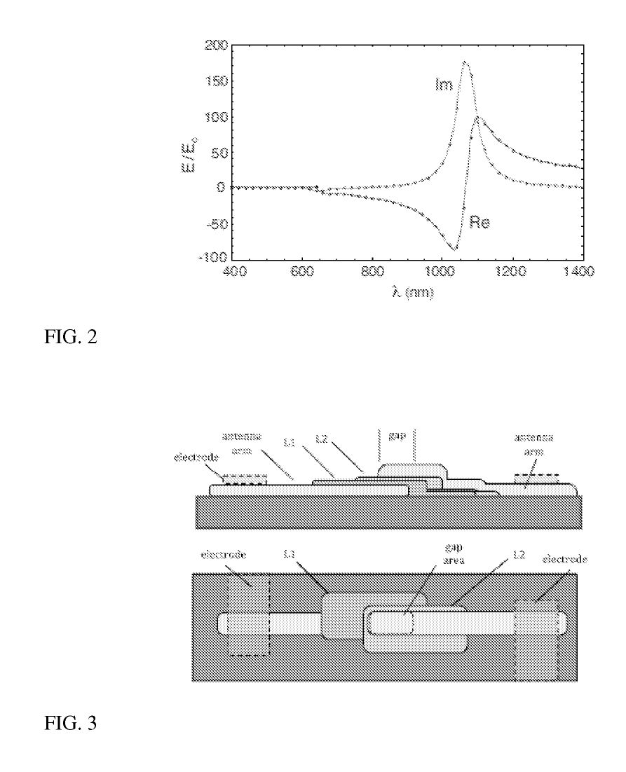

Illustrative non-limiting embodiments provide an optical antenna structure with enhanced performance and a method for fabricating the optical antenna structure with enhanced performance. To that end, the illustrative non-limiting embodiments provide an optical antenna structure that is characterized as an at least partially (vertically) stacked optical antenna structure. The stacked optical antenna structure is further characterized by a stacked structure at an overlapping location of the stacked optical antenna structure, as illustrated within the perspective-view diagram of FIG. 1(a), where an interstitial gap layer is shown in phantom located and formed as a horizontal planar layer interposed between two antenna arms of the stacked optical antenna structure, where the two antenna arms of the stacked optical antenna structure do not contact. Absent from the illustration within FIG. 1 is a base substrate upon or over which is located and formed the stacked optical antenna structure.

Principally, a stacked optical antenna structure in accordance with the embodiments contrasts with a planar optical antenna structure which features a purely lateral and co-planar arrangement of a plurality of antenna arms that are separated by a gap that further includes a gap filling material. Notwithstanding differences in particular geometry of a stacked optical antenna structure and a planar optical antenna structure, the spectral and angular responses of a stacked optical antenna structure and a planar optical antenna structure are often similar since both depend upon an overall length and width of the antenna arms, given that the geometric details of the overlap region generally introduce but minor changes in an optical antenna performance.

The gap area of a stacked optical antenna structure in accordance with the embodiments is defined in cross-sectional area by a degree of projected overlap of the antenna arms, which is typically from about 10 to about 50 nanometers in both of the antenna arm planar directions for a stacked optical antenna operative in the visible or near-infrared wavelength region. However, the overlap distance of the antenna arms within a stacked optical antenna structure in accordance with the embodiments depends on the operating wavelength of the stacked optical antenna structure and can reach more than a micrometer in the microwave wavelength range regime. Also to be considered within the context of certain embodiments is an antenna arm vertical sidewall overlap contribution to a gap area which may occur under circumstances where at least one particular antenna arm layer is not formed as a planar or a planarized antenna arm, and where the non-planar or non-planarized antenna arm layer overlaps both a horizontal end portion of another particular antenna arm layer and an adjacent vertical sidewall portion of the other particular antenna arm layer.

The gap width within a stacked optical antenna in accordance with the embodiments will typically be from about 1 to about 10 nanometers, but can be any value as long as the value is small in comparison with the wavelength of stacked optical antenna operation and the length of the antenna arms, which will typically be from about 50 to about 200 nanometers, for stacked optical antennas operating in the visible wavelength range. Thus, dimensions of a stacked optical antenna in accordance with the embodiments are generally considerably smaller than a wavelength range of optical radiation that may be characterized or analyzed using a stacked optical antenna structure in accordance with the embodiments.

Within a stacked optical antenna structure in accordance with the embodiments, an interstitial gap width may approach an atomic monolayer in size and an interstitial gap layer material may be defined in composition to atomic precision, for instance by use of a molecular beam epitaxy deposition method for depositing an interstitial gap layer material. The interstitial gap layer material may generally be deposited using deposition techniques known from the microelectronic structure and microelectronic device fabrication art, and in particular the semiconductor structure and semiconductor device fabrication art.

As indicated above, FIG. 1(a) shows a schematic perspective view diagram of a stacked optical antenna structure, which here is a linear antenna, in accordance with the embodiments. The stacked optical antenna structure as illustrated in FIG. 1(a) comprises two planar separate antenna arms (i.e., typically formed of a good conductor, such as but not limited to gold, aluminum, or silver) of length about 80 nanometers each, thickness about 10 nanometers each and width about 10 nanometers each for a stacked optical antenna structure operative in the near infrared wavelength range. The two planar antenna arms overlap near a central field region of the stacked optical antenna over a distance of about 10 nanometers, where the two planar antenna arms are separated by about a 4 nanometer thick gap that includes the interstitial gap layer (the location of which is highlighted in phantom in FIG. 1(a)). As is understood by a person skilled in the art, the stacked optical antenna dimensions as illustrated in FIG. 1(a) are optimized for a stacked optical antenna resonance at a wavelength of λ=1060 nanometers in the near infrared region. For stacked optical antenna operation at other wavelengths the stacked optical antenna dimensions necessarily have to be scaled accordingly.

For example, for operation of a stacked optical antenna at a wavelength of λ=1 millimeter, the length of the antenna arms within the stacked optical antenna is roughly about 250 micrometers. However, the thickness of the interstitial gap layer remains in the 1 to 10 nanometer range.

The stacked optical antenna structure as is illustrated in FIG. 1(a) is optically illuminated, for example, by a plane optical wave with a wavelength λ=1060 nanometers at normal incidence and polarized along the stacked optical antenna axis from left to right (or right to left) in FIG. 1(a). The same optical antenna structure can be operated in a transmitting mode, that is, for radiating waves at a wavelength of λ=1060 nanometers.

FIG. 1(b) depicts a field distribution simulation for the stacked optical antenna structure of FIG. 1(a) calculated by the finite difference time domain code for λ=1060 nanometers and ε_{Au}=−48+i3.4. The electric field is strongly enhanced in the interstitial gap region. The intensity in the interstitial gap region is greater than a factor of 30 higher than the intensity at the extremities of the antenna arms, and four orders of magnitude greater than the intensity of the incident optical radiation field. For comparison, FIG. 1(c) shows the electric field distribution for a planar optical antenna consisting of the same elements as the stacked optical antenna. The electric fields in the gaps are similar, indicating that the stacked optical antenna structure features all the desired properties of a standard gap planar optical antenna structure while enabling a potentially simpler and more accurate or precise fabrication process, in particular of the interstitial gap layer.

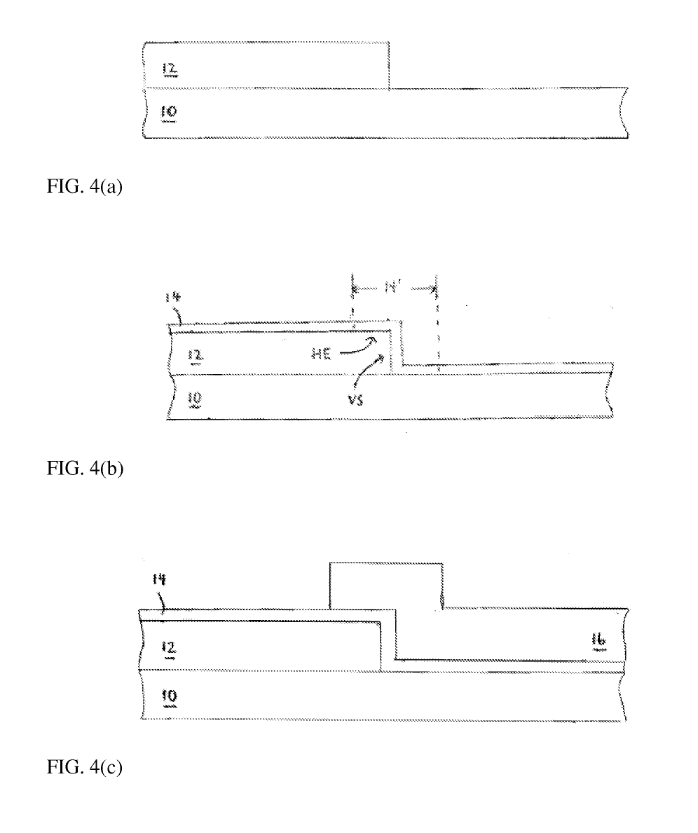

FIG. 2 shows a graph illustrating a calculated intensity enhancement in the center of the gap of the stacked optical antenna shown in FIG. 1(a) and FIG. 1(b) as a function of wavelength. The spectrum features a resonance at λ=1060 nanometers. The field in the gap and its spectral dependence can be tuned by the stacked optical antenna geometry, such as but not limited to the antenna arm length and the stacked optical antenna profile. For example, a stacked optical antenna in accordance with the embodiments may be shaped into a bow-tie optical antenna geometry or any other optical antenna geometry. As well, planar metal-dielectric-metal structures may also be considered for the fabrication of plasmonic nanogap resonators related to the embodiments.

In accordance with the illustrative non-limiting embodiments that follow, particular fabrication options for a stacked optical antenna with particular interstitial gap layers will be described in detail for particular examples. These subsequent illustrative embodiments are based on the properties and characteristics of the interstitial gap layer within a stacked optical antenna structure.

Particular desirable characteristics of a stacked optical antenna structure in accordance with the embodiments with respect to an interstitial gap layer include: (a) a particularly small distance from an antenna arm to a center of a gap; (b) an isolation of an interstitial gap layer material from environmental exposure by the presence of the antenna arms; and (c) an increased electric field within a gap due to a reduced gap width.

Moreover, with respect particularly to materials of composition of the interstitial gap layer, the following considerations are appropriate:

1. The interstitial gap layer may comprise any material suitable for deposition, in particular molecular beam epitaxial deposition, or other thin film deposition techniques.

2. The interstitial gap layer can comprise any of several different materials even, for instance, a p- and an n-semiconductor, forming a p-n or a p-i-n junction interposed between a plurality of antenna arms.

3. The interstitial gap layer width interposed between a plurality of antenna arms may be precisely adjustable down to the atomic level since the interstitial gap layer may be precisely deposited to the atomic level.

4. Any atomic or molecular electronic process that includes fluorescence from the interstitial gap layer may proceed with enhanced speed and efficiency within a stacked optical antenna structure in accordance with the embodiments due to short distances within the interstitial gap layer and efficient coupling to the stacked optical antenna arms.

When an interstitial gap layer within a stacked optical antenna structure in accordance with the embodiments comprises or consists of, for example, a material with large optical nonlinearity, the stacked optical antenna device that results from operation of the stacked optical antenna structure may become a frequency mixer element emitting, for example, at ν3=ν1+/−ν2 when optical waves at frequency ν1 and ν2 are incident upon the stacked optical antenna structure. In principle, any nonlinear process can be exploited by a stacked optical antenna structure in accordance with the embodiments, with applications ranging from low-frequency electro-optics to wave mixing, high harmonic generation, and optical switching. Note that phase-matching, co-linearity, and high transparency are not required for a stacked optical antenna structure in accordance with the embodiments due to the sub-wavelength dimensions of the interstitial gap layer, and that this feature of the embodiments allows a much wider selection of materials with large nonlinear susceptibilities.

The limited thickness of the interstitial gap layer in the interstitial gap within a stacked optical antenna structure in accordance with the embodiments favors the incorporation therein of just one quantum dot, another single active molecule, or alternatively some other single defect center. The presence of just one of the foregoing components is a prerequisite for the emission of a single photon or an entangled photon pair as needed in optical communication and encryption technologies and methodologies.

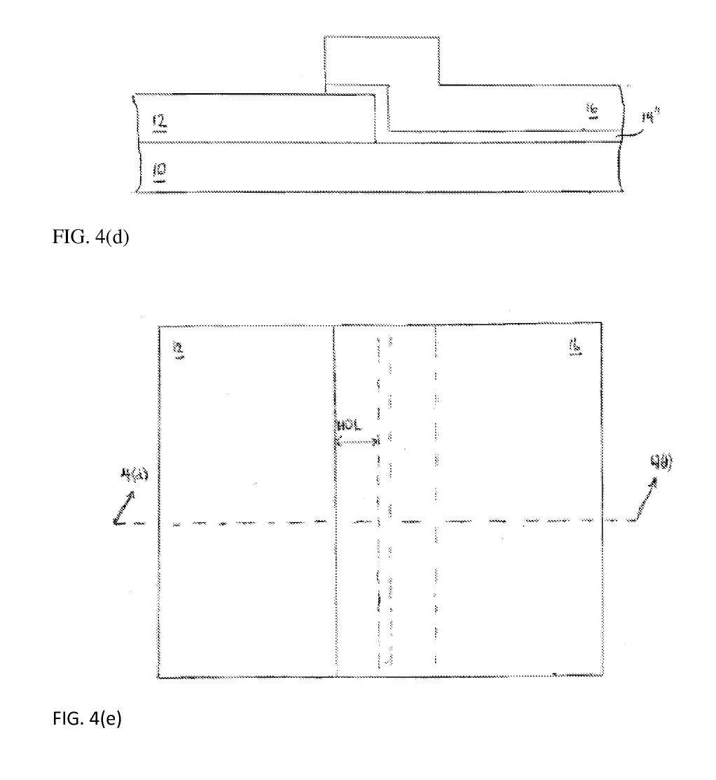

Further functionality may arise if the antenna arms of the stacked optical antenna structure in accordance with the embodiments are contacted to a voltage source (dc or low frequency ac) or a detector network (see, e.g., FIG. 3 which shows by implication a base substrate, two antenna arms as designated and two interstitial layers designated as L1 and L2 and intended as semiconductor p-n junction forming layers). Contacting the antenna arms with transparent (e.g., indium tin oxide) wires (i.e., electrodes), by attaching thin transparent wires to optically neutral points on the antenna arms, or by induction of the antenna arms from neighboring wires, will not disturb the optical antenna effect of a stacked optical antenna structure in accordance with the embodiments. In such a configuration, the interstitial gap layer can function as the gap of a tunneling junction, capable of feeding current induced light into the lobes of the antenna or light-induced current into the antenna arms. The charge transfer across the interstitial gap layer can be further controlled by molecules, quantum dots, or p-n type structures with strong charge-transfer transitions. Fabrication of such tunneling junctions requires precision down to the atomic level, for which the stacked optical antenna geometry with its planar gap structure offers clear fabrication advantages over in-plane planar optical antennas. The limited thickness of the interstitial gap layer reduces losses of photocurrent to or from the electrodes and increases the speed of emission, respectively, of current generation in the photoelectric element. For both cases, the speed is further increased by an optimally adapted stacked optical antenna structure.

Last, for an organic light-emitting diode material, the protection of the active layer by the arms of the stacked optical antenna structure in accordance with the embodiments may be beneficial for stability of the stacked optical antenna structure.

In conclusion, a stacked optical antenna structure in accordance with the embodiments offers a large choice of materials and dimensions for an interstitial gap layer. Depending on the interstitial gap layer material, a stacked optical antenna structure in accordance with the embodiments may interact in various ways with visible light waves, and also with radiation in the ultraviolet, infrared, terahertz and microwave radiation wavelength ranges. When connected to an electrical network, electro-optic (i.e., light emitting diode) and photoelectric (i.e., photovoltaic) effects can be exploited. The stacked optical antenna with interstitial gap layer in accordance with the embodiments hence considerably enlarges the range of applications of optical antennas.

In accordance with the above description, exemplary non-limiting embodiments provide a stacked optical antenna structure and a method for fabricating the stacked optical antenna structure. A stacked optical antenna structure in accordance with the embodiments includes a first antenna arm located and formed over a substrate. A stacked optical antenna structure in accordance with the embodiments also includes an interstitial gap layer located and formed over at least a portion of the first antenna arm. Finally, the stacked optical antenna structure in accordance with the embodiments also includes a second antenna arm located and formed over at least a portion of the interstitial gap layer that is located and formed over the first antenna arm. Typically, the second antenna arm and the first antenna arm incompletely overlap.

Within the context of such a stacked optical antenna structure in accordance with the embodiments, an interstitial gap interposed between the first antenna arm and the second antenna arm is defined by a thickness of a deposited interstitial gap layer rather than being determined in a lithography process step.

A stacked optical antenna structure in accordance with the embodiments may include any of several different types of materials for the interstitial gap layer that may be selected to provide different physical properties and performance characteristics to the stacked optical antenna structure.

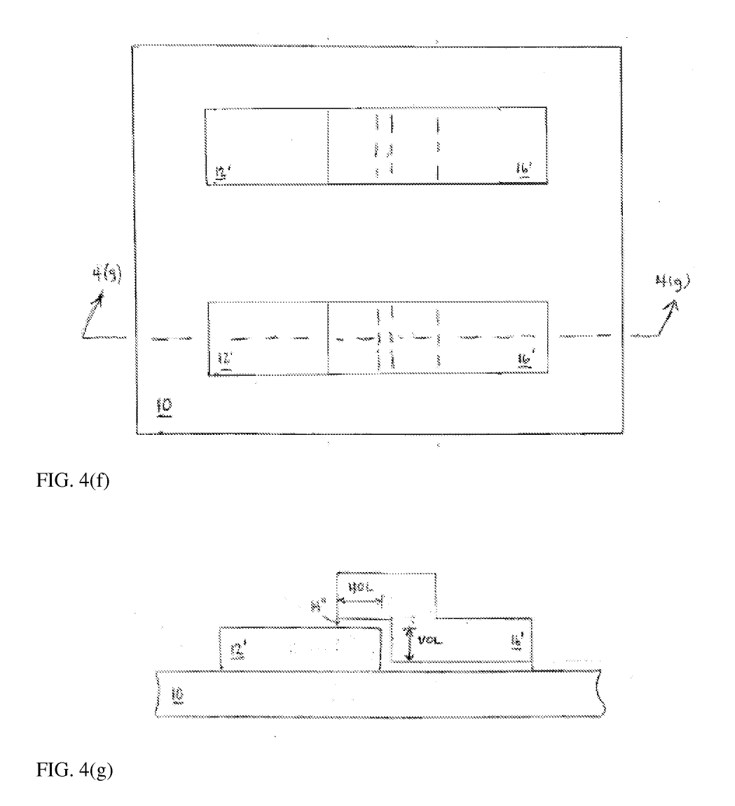

FIG. 4(a) to FIG. 4(g) show a series of schematic cross-sectional and plan-view diagrams illustrating the results of progressive process stages in fabricating a stacked optical antenna structure in accordance with a particular non-limiting embodiment.

FIG. 4(a) shows a schematic cross-sectional diagram of the stacked optical antenna structure at an early stage in the fabrication thereof in accordance with the particularly illustrated non-limiting embodiment.

FIG. 4(a) shows a substrate 10 having located and formed upon a portion thereof (i.e., a left hand portion thereof) a first antenna arm material layer 12. Within this particular embodiment, the substrate 10 and the first antenna arm material layer 12 may comprise materials, and be formed using methods, that are otherwise generally conventional in the microelectronic fabrication art, and in particular the optoelectronic fabrication art.

For example, the substrate 10 may comprise any of several types of substrate materials that are otherwise generally conventional in the optoelectronic fabrication art. More particularly, the substrate 10 may comprise a substrate material including but not limited to a transparent substrate material which could be deposited as a film on a secondary substrate of arbitrary composition. Under certain circumstances the substrate 10 may also comprise an opaque substrate.

Such transparent substrate materials may include, but are not necessarily limited to, glass substrate materials, certain ceramic substrate materials and certain semiconductor substrate materials, where transparency is considered with respect to a particular incoming radiation wavelength range. The substrate material is often selected within the context of this range of optical radiation that is intended to be characterized or processed by a stacked optical antenna device that results from operation of the stacked optical antenna structure in accordance with the embodiments.

In addition, and within the non-limiting embodiment that is illustrated in FIG. 4(a), the first antenna arm material layer 12 typically comprises a metal or metal alloy first antenna arm material, such as but not limited to a gold, gold alloy, silver, silver alloy, copper, copper alloy, aluminum, aluminum alloy, platinum, platinum alloy, palladium, palladium alloy or other metal or other metal alloy first antenna arm material. Typically and preferably, the first antenna arm material layer 12 has a thickness from about 10 to about 50 nanometers for stacked optical antenna applications in the visible wavelength range.

The stacked optical antenna structure whose schematic cross-sectional diagram is illustrated in FIG. 4(a) may be fabricated using any of several methods, including in particular a masked direct subtractive etch method and a masked lift-off method, to provide the first antenna arm material layer 12 as a slab located and formed upon a left hand side of the substrate 10.

FIG. 4(b) shows a schematic cross-sectional diagram illustrating the results of further processing of the exemplary non-limiting stacked optical antenna structure whose schematic cross-sectional diagram is illustrated in FIG. 4(a).

FIG. 4(b) shows an interstitial gap layer 14 located and formed covering both the first antenna arm material layer 12 and remaining exposed portions of the substrate 10, and in particular upon a horizontal end HE and an adjacent vertical sidewall VS of the first antenna arm material layer 12. Alternatively, FIG. 4(b) also shows the dimensions of a patterned interstitial gap layer 14′ that covers only the horizontal end HE portion and the vertical sidewall VS of the first antenna arm material layer 12 and may be patterned from the interstitial gap layer 14. As will be illustrated in further detail below, the interstitial gap layer 14 may have advantages in comparison with the patterned interstitial gap layer 14′ within the context of further processing of the stacked optical antenna structure whose schematic cross-sectional diagram is illustrated in FIG. 4(b). As is illustrated by implication within the schematic cross-sectional diagram of FIG. 4(b), the patterned interstitial gap layer 14′ is patterned from the interstitial gap layer 14 that is located and formed covering all exposed surfaces of the first antenna arm material layer 12 and the substrate 10.

As is illustrated within the schematic cross-sectional diagram of FIG. 4(b) each of the interstitial gap layer 14 and the patterned interstitial gap layer 14′ is intended as a conformal single thickness layer. Nonetheless, the interstitial gap layer 14 may under certain circumstances be directionally deposited from an angle, such that the vertical sidewall VS and some range of the substrate 10 to the right of the vertical sidewall VS may be left uncoated. Within the context of the exemplary non-limiting embodiments, the interstitial gap layer 14 or the patterned interstitial gap layer 14′ is intended to comprise any of several interstitial gap materials that may be intended within the context of possible examples of embodiments, as discussed in further detail above. Such interstitial gap materials may include, but are not necessarily limited to dielectric interstitial gap materials, semiconductor junction interstitial gap materials, large nonlinear susceptibility interstitial gap materials, conductive oxide interstitial gap materials, and otherwise transparent or dielectric interstitial gap materials having fluorescing or other optically active entities incorporated therein.

FIG. 4(c) shows a schematic cross-sectional diagram illustrating the results of further processing of the stacked optical antenna structure whose schematic cross-sectional diagram is illustrated in FIG. 4(b). FIG. 4(c) shows a second antenna arm material layer 16 located and formed upon the interstitial gap material layer 14. Within the illustrative non-limiting embodiments, the second antenna arm material layer 16 may comprise the same or different antenna arm material in comparison with the first antenna arm material layer 12. Typically, the second antenna arm material layer 16 comprises the same antenna arm material as the first antenna arm material layer 12. Typically, the second antenna arm material layer 16 has a thickness from about 10 to about 50 nanometers for operation in the visible wavelength range.

Desirably within the embodiments, the second antenna arm material layer 16 may be formed while using a direct subtractive etch method while using the interstitial gap material layer 14 as an etch stop layer. Also, as illustrated in FIG. 4(c), and in contrast with FIG. 1(a) and FIG. 1(b), the second antenna arm layer 16 is not planar, since at least implicitly within FIG. 1(a) and FIG. 1(b) each of the antenna arm layers is intended to be located and formed upon a planar surface, which may comprise a planarized dielectric material layer surface adjoining and co-planar with a lower lying first antenna arm.

FIG. 4(d) shows a schematic cross-sectional diagram illustrating the results of further processing of the stacked optical antenna structure whose schematic cross-sectional diagram is illustrated in FIG. 4(c). FIG. 4(d) shows the results of patterning the interstitial gap material layer 14 to provide an interstitial gap material layer 14″, while using the second antenna arm material layer 16 as a mask layer. The foregoing patterning of the interstitial gap material layer 14 to provide the interstitial gap material layer 14″ may be effected using etch methods and materials that are otherwise generally conventional in the microelectronic fabrication art, and in particular the optoelectronic fabrication art. Such patterning methods may include, but are not necessarily limited to sputter etch methods and reactive ion etch methods.

FIG. 4(e) shows a schematic plan-view diagram of a stacked optical antenna structure that corresponds with the stacked optical antenna structure whose schematic cross-sectional diagram is illustrated in FIG. 4(d).

As is illustrated within the schematic plan-view diagram of FIG. 4(e), a plan-view diagram of the stacked optical antenna structure shows the first antenna arm material layer 12 and the second antenna arm material layer 16, as well as the horizontally overlapped HOL region of the first antenna arm material layer 12 and the second antenna arm material layer 16. Also considered within the context of the instant embodiment is a vertical sidewall overlapped region of the first antenna arm material layer 12 with respect to the second antenna arm material layer 16 as illustrated further below.

FIG. 4(f) shows a schematic plan-view diagram of a stacked optical antenna structure illustrating the results of further processing of the stacked optical antenna structure whose schematic plan-view diagram is illustrated in FIG. 4(e). FIG. 4(f) shows the results of patterning the first antenna arm material layer 12 and the second antenna arm material layer 16 and also (by implication) the interposed interstitial gap layer 14″ to form a first antenna arm 12′ and a second antenna arm 16′ which are visible in a plan-view. Each of the first antenna arm 12′ and the second antenna arm 16′ will typically have a linewidth from about 10 to about 50 nanometers and a length from about 50 to about 200 nanometers for operation in the visible wavelength range.

As is understood by a person skilled in the art, the stacked optical antenna structure geometry that is illustrated in FIG. 4(f) corresponds with a linear stacked optical antenna structure geometry. However, the embodiments are not intended to be so limited to a linear stacked optical antenna structure geometry. Rather, a stacked optical antenna structure in accordance with the embodiments may be provided in a geometry including but not limited to a linear geometry, an offset angle geometry, a bow-tie geometry, a Yagi-Uda geometry, a loop geometry, or a log-normal geometry. In general, the term “stacked optical antenna” refers to any geometry with incompletely overlayed and overlapped antenna arms intended for receiving or transmitting optical radiation.

The patterning of the stacked optical antenna structure whose schematic plan-view diagram is illustrated in FIG. 4(e) to provide the stacked optical antenna structure whose schematic plan-view diagram is illustrated in FIG. 4(f) may be effected using methods and materials analogous, equivalent or identical to the methods and materials that are used for previous patterning process steps in forming the stacked optical antenna structure whose schematic cross-sectional diagram is illustrated in FIG. 4(f).

FIG. 4(g) shows a schematic cross-sectional diagram corresponding with the stacked optical antenna structure whose schematic plan-view diagram is illustrated in FIG. 4(f). As is illustrated more clearly within FIG. 4(g), the stacked optical antenna structure includes the first antenna arm 12′, the interstitial gap layer 14′″ and the second antenna arm 16′. Also shown in FIG. 4(g) is a horizontal overlap HOL region at the horizontal end of the first antenna arm 12′ (i.e. as designated HE in FIG. 4(b)) and a vertical overlap VOL region at the adjacent vertical sidewall of the first antenna arm 12′ (i.e., as designated VS in FIG. 4(b)) of the second antenna arm 16′ with respect to the first antenna arm 12′. As is illustrated in FIG. 4(g) the second antenna arm 16′ covers both the horizontal end of the first antenna arm 12′ and the vertical sidewall of the first antenna arm 12′. Given the presence of both the horizontal overlap HOL region and the vertical overlap VOL region and the intervening upper edge of the first antenna arm 12′, enhanced or unique electrical properties may be realized when operating a stacked optical antenna device that results from the stacked optical antenna structure whose schematic cross-sectional diagram is illustrated in FIG. 4(g).

As noted above, a stacked optical antenna structure may use any of several interstitial gap layers 14, 14′, 14″ or 14′″ of different interstitial gap materials for purposes of providing a stacked optical antenna structure that may be used in any of several functions.

All references, including publications, patent applications, and patents cited herein are hereby incorporated by reference in their entireties to the extent allowed and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

Thus, the foregoing embodiments are illustrative of the invention rather than limiting of the invention. Revisions and modifications may be made to methods, materials, structures and dimensions of a stacked optical antenna structure and a method for fabrication thereof within the context of the illustrative embodiments, while still providing a stacked optical antenna structure or related method for fabrication thereof in accordance with the embodiments, further in accordance with the accompanying claims.

What is claimed is:

1. An optical antenna structure comprising:
a first antenna arm located over a substrate;
an interstitial gap layer located over at least a portion of the first antenna arm; and
a second antenna arm located over at least a portion of the interstitial gap layer that is located over the first antenna arm.

2. The optical antenna structure of claim 1 wherein the first antenna arm and the second antenna arm incompletely overlap.

3. The optical antenna structure of claim 1 wherein:
the interstitial gap layer is located over a horizontal end of the first antenna arm and an adjacent vertical sidewall of the first antenna arm; and
the second antenna arm is located over the interstitial gap layer and covering both the horizontal end of the first antenna arm and the adjacent vertical sidewall of the first antenna arm.

4. The optical antenna structure of claim 1 wherein the substrate comprises a transparent substrate.

5. The optical antenna structure of claim 1 wherein the substrate comprises an opaque substrate.

6. The optical antenna structure of claim 1 wherein the second antenna arm does not contact the first antenna arm.

7. The optical antenna structure of claim 1 wherein each of the first antenna arm and the second antenna arm is planar.

8. The optical antenna structure of claim 1 wherein at least one of the first antenna arm and the second antenna arm is not planar.

9. The optical antenna structure of claim 1 wherein:
the first antenna arm and the second antenna arm each have a linewith from about 10 to about 50 nanometers.
the first antenna arm and the second antenna arm each have a length from about 50 to about 200 nanometers;
the first antenna arm and the second antenna arm overlap for an overlap distance from about 10 to about 50 nanometers; and
the interstitial gap layer has a thickness from about 1 to about 10 nanometers.

10. The optical antenna structure of claim 1 wherein each of the first antenna arm and the second antenna arm comprises a metal conductor antenna arm material.

11. The optical antenna structure of claim 10 wherein the metal conductor antenna arm material comprises a metal selected from the group consisting of gold, gold alloy, silver, silver alloy, copper, copper alloy, aluminum and aluminum alloy, platinum and platinum alloy, palladium and palladium alloy metals.

12. The optical antenna structure of claim 1 wherein the interstitial gap layer comprises a dielectric material.

13. The optical antenna structure of claim 1 wherein the interstitial gap layer comprises a non-linear optic material.

14. The optical antenna structure of claim 1 wherein the interstitial gap layer comprises an optically active material incorporated into a dielectric material.

15. The optical antenna structure of claim 1 wherein the interstitial gap layer comprises a semiconductor material.

16. The optical antenna structure of claim 1 wherein the interstitial gap layer comprises a conductive oxide material.

17. A method for fabricating an optical antenna comprising:
forming over a substrate a first antenna arm;
forming over at least a portion of the first antenna arm an interstitial gap layer; and
forming over at least a portion of the interstitial gap layer formed over the first antenna arm a second antenna arm.

18. The method of claim 17 wherein forming the first antenna arm and forming the second antenna arm provides that the first antenna arm and the second antenna arm incompletely overlap.

19. The method of claim 17 wherein:
forming the interstitial gap layer forms the interstitial gap layer over a horizontal end of the first antenna arm and adjacent vertical sidewall of the first antenna arm; and
forming the second antenna arm forms the second antenna arm over the interstitial gap layer and covering the horizontal end of the first antenna arm and the adjacent vertical sidewall of the first antenna arm.

20. The method of claim 17 wherein forming the first antenna arm and forming the second antenna arm provides that each of the first antenna arm and the second antenna arm is planar.

21. The method of claim 17 wherein forming the first antenna arm and forming the second antenna arm provides that at least one of the first antenna arm and the second antenna arm is not planar.

22. The method of claim 17 wherein the forming the interstitial gap layer provides the interstitial gap layer as a planar layer

23. The method of claim 17 wherein the forming the interstitial gap layer provides the interstitial gap layer as a non-planar layer.

24. The method of claim 17 wherein forming the second antenna arm uses the interstitial gap layer as an etch stop layer.

25. The method of claim 17 wherein forming the interstitial gap layer provides the interstitial gap layer formed of an interstitial gap material selected from the group consisting of dielectric materials, non-linear optic materials, conductive oxide materials, transparent materials including an optically active material and semiconductor materials.
